(19) United States
(12) Patent Application Publication
(10) Pub. No.: US 2023/0390720 A1
(43) Pub. Date: Dec. 7, 2023

(54) CONTAINED SINGLE-USE POWDER INDUCTION SYSTEM AND METHOD OF USE

(71) Applicant: Genentech, Inc., South San Francisco, CA (US)

(72) Inventors: Hongbo Mike Su, South San Francisco, CA (US); Hamza Ahsan, South San Francisco, CA (US); Jovilo Rotao Custodio, Jr., South San Francisco, CA (US); Dave Lam, South San Francisco, CA (US); Christian James Randecker, South San Francisco, CA (US); Keila L. Wedow, South San Francisco, CA (US)

(21) Appl. No.: 18/321,199

(22) Filed: May 22, 2023

Related U.S. Application Data
(60) Provisional application No. 63/349,262, filed on Jun. 6, 2022.

(51) Int. Cl. B01F 25/53; B01F 23/50; B01F 25/51; B01F 25/312; B01F 35/71; B01F 35/00

(52) U.S. Cl. CPC B01F 25/53; B01F 23/56; B01F 23/59; B01F 25/51; B01F 2101/22; B01F 25/31243; B01F 35/711; B01F 35/7176; B01F 35/187; B01F 25/3121

(57) ABSTRACT

A system and method is configured for inducing powder for pharmaceutical production. The system is configured to inducing the powder in a powder container into a powder flow pathway toward a branched lumen, wherein the powder container is a single use closed container, and wherein an air inlet is coupled to the powder flow pathway downstream of the powder container and upstream of the branched lumen. The powder is induced into a recirculation flow pathway toward a mix tank, wherein a pump assembly is located in the recirculation flow pathway. The powder is recirculated in the recirculation flow pathway toward the mix tank having a controlled air flow rate and recirculation flow rate.

### CROSS REFERENCE TO RELATED APPLICATIONS

This application claims the benefit of priority under 35 U.S.C. § 119(e) to co-pending U.S. Provisional Patent Application Ser. No. 63/349,262, filed Jun. 6, 2022. The disclosure of the application is incorporated by reference in its entirety.

### BACKGROUND

Powder induction systems are used to disperse powders into liquids. Current powder addition process typically adds powder above the liquid surface. This type of powder addition process can be difficult as hydrophobic powders often resist hydration and mixing. High mixing power is typically needed to overcome powders floating on top of the liquid surface in order to hydrate and disperse the powder into solution. This can increase the mixing time required for overall solution prep time.

A primary objective of powder induction is to add powder via subsurface due to a lack of infrastructure to add the powder to a top surface. A secondary objective is to hydrate and to initially introduce powder into a turbulent fluid stream created via a pump which facilitates hydration of powders and leads to efficient mixing.

Furthermore, current powder induction systems (both single-use and multi-use systems) typically have no or very limited powder containment during addition of powder to the system. The powder addition process can undesirably release dust into the environment, which can create cross contamination risk. Moreover, current systems in a single-use facility typically require a user to lift powder into a potentially high-positioned bin for insertion into the system, which can be the source of various safety and ergonomic risks as well as operational and design challenges related to equipment and facility.

### SUMMARY

In view of the foregoing, there is a need for improved powder induction systems and use thereof.

In one aspect, there is disclosed a method of inducing powder for pharmaceutical production, the method comprising: inducing the powder in a powder container into a powder flow pathway toward a branched lumen, wherein the powder container is a single use closed container, and wherein an air inlet is coupled to the powder flow pathway downstream of the powder container and upstream of the branched lumen; inducing the powder from the branched lumen into a recirculation flow pathway toward a mix tank, wherein a pump assembly is located in the recirculation flow pathway; and recirculating the powder in the recirculation flow pathway toward the mix tank, wherein the powder flow pathway and the recirculation flow pathway are collectively an enclosed pathway in which an air flow rate from the air inlet is controlled from 0 to 10 SCM/Min and recirculation flow rate in the recirculation flow pathway is controlled from 0 to 500 L/Min.

In another aspect, there is disclosed a powder induction system, comprising: a powder container containing a powder, the powder container positioned along a powder flow pathway such that the powder container introduces the powder into the powder flow pathway; an air inlet coupled to the powder flow pathway, the air inlet configured to introduce air into the powder flow pathway downstream of the powder container; a manifold coupled to the powder flow pathway downstream of the air inlet, wherein the manifold fluidly connects the powder flow pathway to a recirculation flow pathway; and a pump assembly coupled to the recirculation flow pathway, wherein the pump assembly is configured to cause a pressure differential to cause powder to pass from the powder container through the powder flow pathway and into the recirculation flow pathway toward a mix tank, wherein the manifold introduces powder into the recirculation flow pathway upstream of the pump assembly.

In another aspect, there is disclosed a powder induction system, comprising: a powder container containing a powder, the powder container positioned along a powder flow pathway such that the powder container introduces the powder into the powder flow pathway; an air inlet coupled to the powder flow pathway, the air inlet configured to introduce air into the powder flow pathway downstream of the powder container; an eductor coupled to the flow pathway downstream of the air inlet, wherein the eductor fluidly connects the powder flow pathway to a recirculation flow pathway and introduces the powder into the powder flow pathway; and a pump assembly coupled to the recirculation flow pathway, wherein the pump assembly is configured to cause a pressure differential to cause powder to pass from the powder container through the powder flow pathway and into the recirculation flow pathway toward a mix tank via the inductor, wherein the powder is added into a liquid stream of the recirculation flow pathway by a vacuum generated by the eductor, wherein the eductor introduces powder into the recirculation flow pathway downstream of the pump assembly.

### BRIEF DESCRIPTION OF THE DRAWINGS

The details of one or more variations of the subject matter described herein are set forth in the accompanying drawings and the description below. Other features and advantages of the subject matter described herein will be apparent from the description and drawings, and from the claims.

FIG. 1 shows a schematic representation of a first embodiment of a power induction system.

FIG. 2 shows a table representation of some exemplary parameters of the powder induction system 100.

FIG. 3 shows a schematic representation of a second embodiment of a power induction system.

FIGS. 4A-4C show an example embodiment of an eductor.

### DETAILED DESCRIPTION

Before the present subject matter is further described, it is to be understood that this subject matter described herein is not limited to particular embodiments described, as such may of course vary. It is also to be understood that the terminology used herein is for the purpose of describing particular embodiments only, and is not intended to be limiting. Unless defined otherwise, all technical terms used herein have the same meaning as commonly understood by one skilled in the art to which this subject matter belongs.

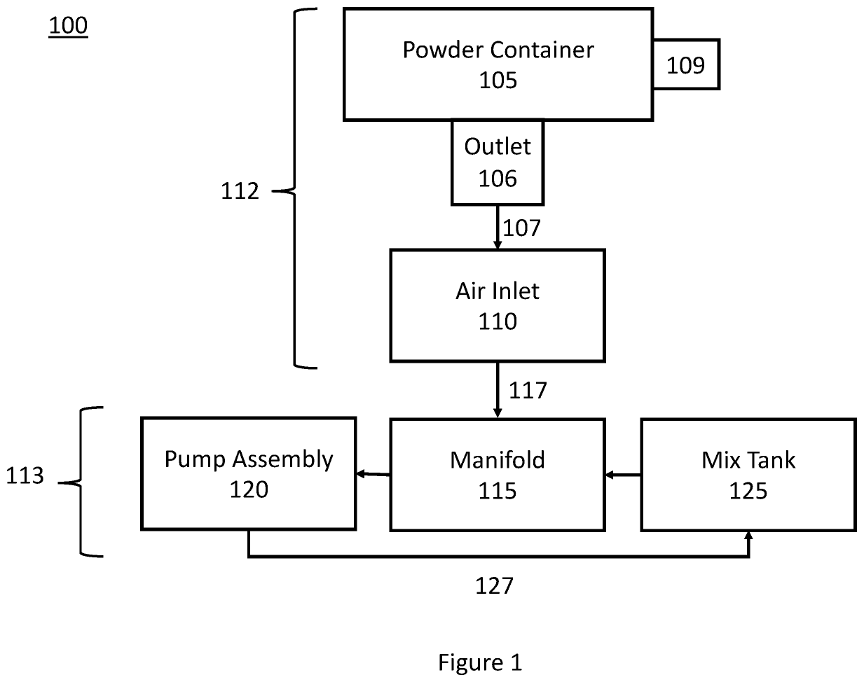

FIG. 1 shows a schematic representation of a first embodiment of a single-use powder induction system 100 configured for use in solution preparation for industrial-scale protein therapeutic biomanufacturing. The system is suitable for a powder induction and mixing process for preparing solutions. The powder induction system 100 includes a powder container 105, an air inlet 110, a manifold 115 (such as a T-manifold, which forms a branched lumen), a pump assembly 120, and a mix tank 125, as described more fully below. These components may be connected via one or more pipes or collection of pipes that collectively form a lumen for passage of fluid therethrough, as described more fully below. The components may also include one or more fluid connectors, clamps, valves, etc. that are configured to enable fluid flow through the system. The air inlet 110 can optionally be configured to sterilize, clean, or otherwise process air. For example, the air inlet 110 can include a filter that cleans or sterilizes air.

The components and corresponding pipes collectively form a flow lumen or flow pathway through which powder passes from within the powder container 105 into the mix tank 125 as a result of a pressure differential provided by the pump assembly 120. Thus, the pump assembly 120 sucks the powder from the powder container 105 and into the mix tank 125 via the components and pipes of the powder induction system 100. The powder is introduced into the flow pathway upstream of the pump assembly 120 in the embodiment of FIG. 1.

The flow pathway includes a powder flow pathway 112 that is formed of the powder container 105 and the air inlet 110 as well as any piping or other components through which powder flows from the powder container 105 toward the manifold 115. The powder flows from the powder container 105 and toward the manifold 115 via the powder flow pathway 112 with the air inlet 110 introducing air into the powder flow pathway 112, as described further below. The flow pathway further includes a recirculation flow pathway 113 that is linked to the powder flow pathway 112 via the manifold 115. The manifold is a pipe, chamber or any lumen that forms a lumen of the flow pathway that branches from the powder flow pathway 112 into the recirculation pathway 113. The recirculation flow pathway 112 includes a continuously recirculating flow loop that includes the mix tank 125 and the pump assembly 120 as well as any piping or other components through which powder and/or a powder solution recirculates between the pump assembly and mix tank 125, as described below. The powder flow pathway 112 (and the powder) initially enters or otherwise transitions into the recirculation pathway 113 at the manifold 115. The recirculation flow pathway flows in a counterclockwise direction relative to FIG. 1 such that the manifold introduces the powder into the recirculation pathway, where the powder then flows into the pump assembly 120 and then to the mix tank 125. The recirculation pathway 113 then flows in a continuous recirculation loop.

With reference still to FIG. 1, the powder container 105 contains a powder that is configured to pass through the various components along the flow pathway toward and eventually into the mix tank 125. The mix tank 125 includes one or more mechanisms configured to mix the powder into a solution. The powders may be, for example, used in various solutions for biopharmaceutical production.

The powder container 105 can be any type of enclosed container, such as a bag, that is configured to contain powder. The powder can be initially contained within a sealed, internal volume of the powder container 105 such that the powder can only exit the powder container 105 into the flow pathway via an outlet 106 of the powder container 105. The powder container 105 can also include a vent 109 through which air can exit or enter the powder container 105. The vent 109 can optionally be connected with a sterile air filter (or other type of air filter) to protect the powder from potential contamination from the environment.

The sealed or closed aspect of the powder container contributes to an enclosed flow pathway to reduce the likelihood of contaminants or any other item unintentionally being introduced into the flow pathway. It also reduces the likelihood of the powder being introduced into the environment external to the flow pathway. As discussed below, the air inlet 110 advantageously introduces air (which may be clean air) into the enclosed flow pathway such as for improving powder fluidity and/or to provide pressure regulation of the powder container.

The outlet of the powder container 105 is fluidly connected to the air inlet 110, such as directly to the air inlet 110, along the flow pathway. Or the powder container 105 can be connected to the air inlet 110 via a conduit 107, such one or more pipes, that provide fluid communication between the powder container 105 and the air inlet 110. A valve, such as a butterfly valve, can optionally be positioned between the powder container 105 and the air inlet 110 for controlling flow therebetween. The valve can be incorporated into the outlet 106 or it can be a separate component positioned between the powder container 105 and the air inlet 110. One or more clamp mechanisms can be used to couple the powder container 110 to the air inlet 110 or to the conduit 107. The type of clamp can vary and can include, for example, a tubing clamp or a pinch clamp that regulates fluid flow. Other devices for regulating fluid flow can also be used.

The air inlet 110 is a mechanism configured to inject, insert, or otherwise introduce air from an air supply/source or other fluid into the flow pathway of the powder induction system 100 at a location downstream of the powder container 105. The air inlet 110 may be manually actuated by a user to introduce the air or it can automatically introduce air upon satisfaction of a triggering condition. The air is introduced from an environment external to the flow pathway. The air inlet 110 introduces the air into the flow pathway such as to avoid or reduce the likelihood of the powder container 105 collapsing as a result of a pressure differential introduced by the pump assembly 120. The air inlet 110 can also introduce air to fluidize the powder as it passes from the powder container 105 toward the mix tank 125 along the flow pathway, then exit from the vent.

The air inlet 110 can further introduce air into the powder container 105. As mentioned, the vent 109 enables release of air (or other substance) from the powder container 105 into the external environment. The vent 109 can also permit entry of air and/or (or other substance) into the powder container from the external environment. The vent 109 can include or be coupled to a sterile air filter.

The flow pathway passes from air inlet 110 and through a conduit 117, where the flow pathway includes a manifold 115, such as a T-manifold. The manifold 115 connects the flow pathway to a mix tank 125. In an embodiment, the powder container is located at a height relative to a ground level wherein the height is lower than a liquid height (or height of a top level of liquid) of the container. The size of the mix tank can be scalable. In an embodiment, the mix tank has a capacity in the range of 600 liters to 10 kiloliters. In another embodiment, the mix tank has a capacity of greater than 10 kiloliters. In another embodiment, the mix tank has a capacity of less than 10 kiloliters.

As mentioned, the pump assembly 120 pumps fluid through the flow pathway to cause the powder to pass from the powder container 105, past the air inlet 110, through the conduit 117 and toward and into the mix tank 125 via the manifold 115 and the pump assembly 120. At least one additional conduit 127 fluidly connects the pump assembly 120 to the mix tank 125 to form a fluid recirculation loop. The pump assembly 120 is configured to achieve a desired flow rate with whatever tubing, connectors and other connectors that are used in the flow pathway. In a non-limiting example, the pump is configured to minimize pulsation and is a centrifugal pump. The pump assembly 120 can collectively be formed of a disposable, single-use pump head that removably couples to a pump mechanism or any drive mechanism. In an embodiment, the pump assembly is a PURALEV 600SU or a PURALEV 2000SU manufactured by Levitronix GMBH.

In use, the powder container 105 is coupled to the flow pathway via the outlet 106. The pump assembly 120 can be activated such that the pump sucks powder from the powder container 105 and into the powder flow pathway 112 via the outlet 106. The air inlet 110 introduces air into the powder flow pathway 112 to fluidize the powder as it flows through the powder flow pathway 112 toward the manifold. As mentioned, the air provided by the air inlet 110 may also pass into the powder container 105. The vent 109 enables venting into the powder container 105 from the outside environment or into the outside environment from the powder container 105.

The fluidized powder flows toward and into the manifold 115, where the fluidized powder initially enters the recirculation flow pathway 113. Once in the recirculation flow pathway 113, the powder flows through the pump assembly 120 and then into the mix tank 125 where it is mixed with liquid from the mix tank 125. The resulting solution then continuously flows through the flow loop of the recirculation flow pathway 113.

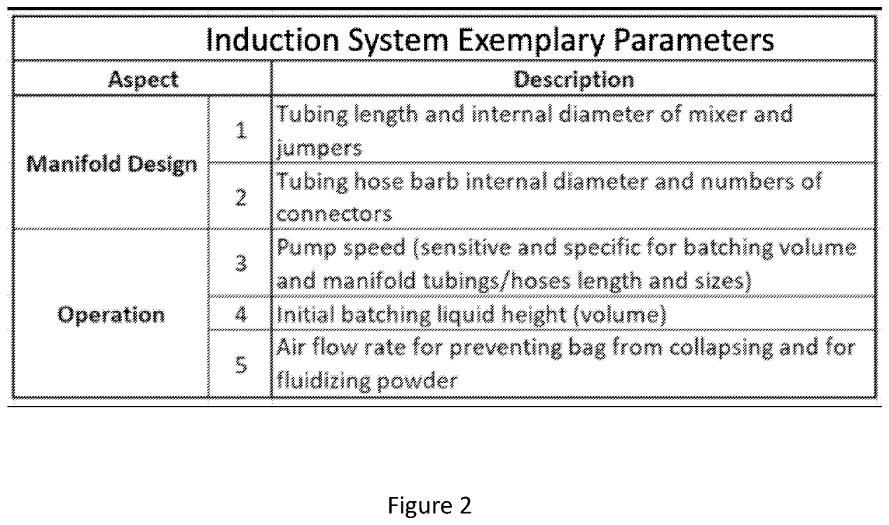

An air flow rate from the air inlet and the recirculation flow rate in the recirculation flow pathway need to be controlled in specific ranges for the stable operation of the powder induction system. In the embodiment of FIG. 1, the pump speed, manifold tubing length and size, connectors sizes, and initial batching volume in the mix tank 125 are exemplary parameters to achieve a control of the air flow rate and the recirculation flow rate within specific ranges for the powder induction system 100. FIG. 2 shows a table representation of some exemplary parameters of the powder induction system 100. In particular, specifications such as the internal diameter of tubing and quantity of connectors (item 2 in FIG. 2) of the manifold are interdependent with the initial batching liquid height (item 4 in FIG. 2) such that a variation in one of these results in a necessary variation in the other to achieve proper operation of the powder induction system 100. This is a result of their influences on the flow rates of the solution to the pump which determine if an air to liquid ratio is below the pump tolerance for a stable pump operation. This may result in a time consuming and costly effort to identify exemplary parameters' operating ranges.

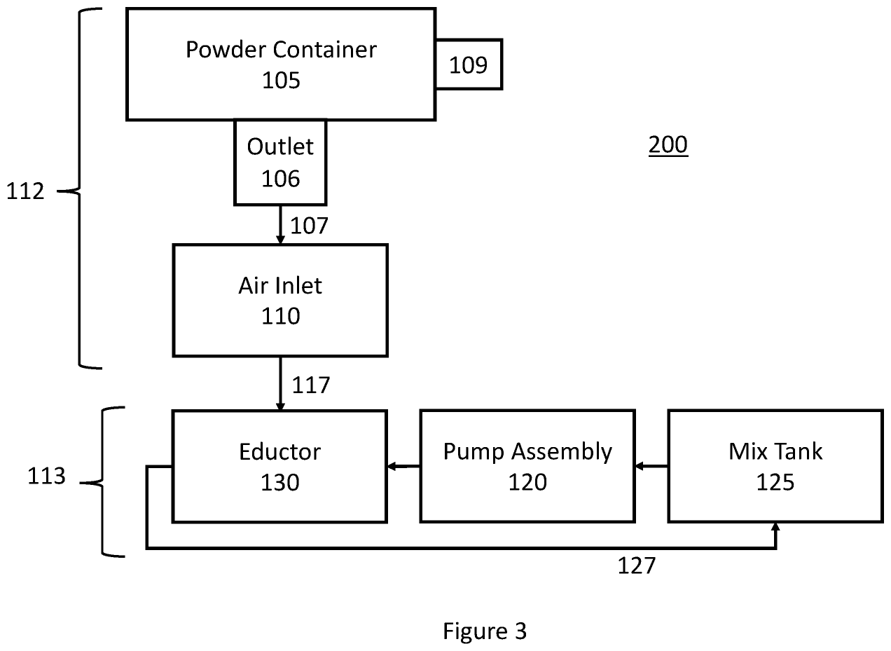

FIG. 3 shows a schematic representation of a second embodiment of a powder induction system 200. This embodiment eliminates the interdependency of the exemplary parameters discussed above. This embodiment includes an eductor 130 (which forms a branched lumen) that links the powder flow pathway 112 to the recirculation flow pathway 113. The eductor is configured to introduce powder into the recirculation flow pathway downstream of the pump assembly 120 relative to the direction of flow through the recirculation flow pathway 113 or relative to an entryway into the recirculation flow pathway. The powder is added into the liquid stream of the recirculation flow pathway 113 by a vacuum generated by the eductor. The vacuum can be robustly achieved and maintained by the Venturi effect of the eductor even with air intrusion. The pump installed upstream of the eductor therefore it is not impacted by air intrusion occurring in the eductor for powder addition. Thus, the pump speed is the only operating parameter to generate a desirable vacuum for a stable powder induction. The feasible operational range of the pump is much broader compared to other powder induction systems. The interdependent relationships stated for the embodiment of the powder induction system 100 including pressure drops of tubes and hydrostatic pressure due to liquid batch volume in the solution prep tank are eliminated. The eductor is configured to employ the Venturi effect for pump operation. It works by converting the pressure energy of a fluid into velocity energy, which can then be used to pump another fluid or transport a solid. In this regard, the eductor has an internal lumen sized and shaped to achieve the Venturi effect or a reduction in fluid pressure that results when a fluid flows through a constricted section (or choke) of a pipe or structure such as the eductor.

With reference to FIG. 3, the powder flow pathway 112 (and the powder) initially enters or otherwise transitions into the recirculation pathway 113 at or via the eductor 130. The recirculation flow pathway flows in a counterclockwise direction relative to FIG. 3 such that the eductor 130 introduces the powder into the recirculation pathway, where the powder then flows into the mix tank 125 and then to the pump assembly 120. The recirculation pathway 113 then flows in a continuous recirculation loop.

As mentioned, the use of the embodiment shown in FIG. 3 including the eductor eliminates the interdependency of the exemplary parameters shown in the table of FIG. 2. This allows use of different mix container configurations and different tubing connections controlling the air flow rate and the recirculation flow rate within specific ranges, which can be important for single-use facilities because the connections and other consumables may vary from run to run.

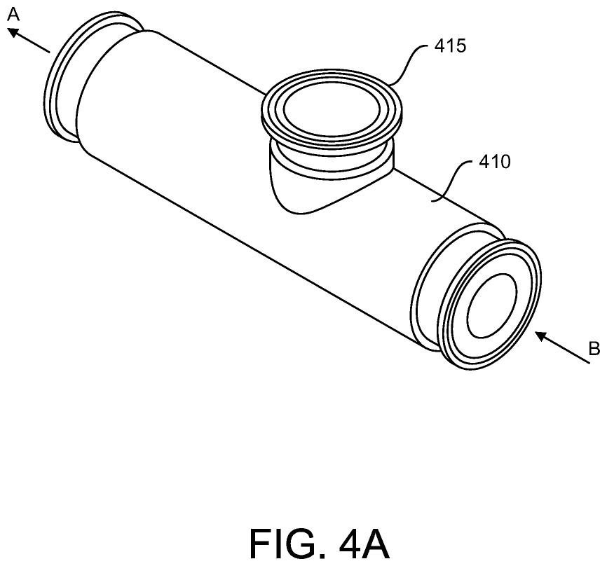

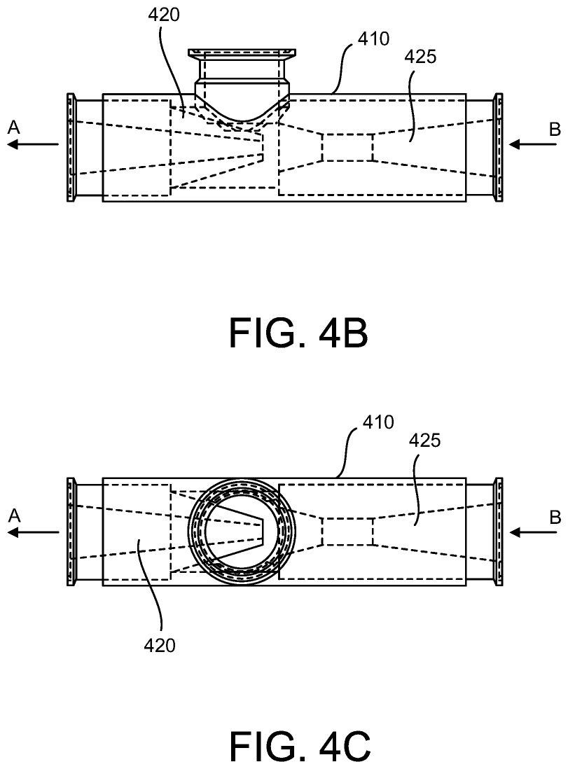

FIG. 4A shows a perspective view of a non-limiting example of an eductor 405 that can be used with the system 200 of FIG. 3. FIG. 4B shows a side view and FIG. 4C shows a top view of the eductor 405 with internal lumens of the eductor shown in phantom. The eductor 405 is formed of a tubular body 410 having an entryway 415, which connects to the conduit 117 (FIG. 3) such that powder/fluid can enter the recirculation pathway 117 and the eductor 405. The entryway 415 branches and lead into an internal lumen 420 that expends outwardly in size moving along a flow direction (represented by arrow A in FIGS. 4A-4C). The flow direction A leads to the mix tank 125 (FIG. 3) along the recirculation pathway 113. As mentioned, the recirculation pathway 113 then flows from the mix tank 125, into the pump assembly and then into the back into the eductor 405, where the recirculation pathway communicates with an internal lumen 425 of the eductor that varies in cross-sectional size. The arrow B in FIGS. 4a-4C represent the flow direction of the recirculation pathway back into the eductor 405. As mentioned, the eductor 405 of FIGS. 4A-4C is a non-limiting example and other eductor configurations are within the scope of this disclosure. The eductor has an internal lumen lumen sized and shaped to achieve the Venturi effect or a reduction in fluid pressure that results when a fluid flows through a constricted section (or choke) of a the internal lumen.

The system 200 is capable of adopting various sizes of tubing, connectors and other components to perform optimally or efficiently for powder induction.

Table 1 below shows exemplary, non-limiting specifications of the preferred range of the air supply and the recirculation flow in the contained single-use powder induction system 100 and 200.

TABLE 1
Preferred range of recirculation flow and air supply
in the contained single-use powder induction system

| Air Supply | Air Supply Pressure (BarG) | Air Flow Rate (SCM/Min) |
|---|---|---|
| | 0-10, more preferably 0.1-2 | 0-10, more preferably 0-1 |
| Recirculation | Pump Delivery Head | Recirculation Flow Rate |
| Flow | Pressure (BarG) | (L/Min) |
| | 0-4 | 0-500, more preferably 5-400 |

Pursuant to Table 1, the air supply pressure is in the range from 0 to 10 BarG, more preferably from 0.1 to 2. The air flow rate is in the range from 0 to 10 SCM/Min (standard cubic meter per minute), more preferably from 0 to 1 SCM/Min. The pump delivery head pressure is in the range from 0 to 4 BarG. The recirculation flow rate is in the range from 0 to 500 L/Min (liters per minute), more preferably from 5 to 400 L/Min. Therefore, in an embodiment, the system is configured such that the powder flow pathway and the recirculation flow pathway are collectively an enclosed pathway in which an air flow rate is controlled from 0 to 10 SCM/Min and the recirculation flow rate is controlled from 0 to 500 L/Min. More preferably, the air flow rate is controlled from 0 to 1 SCM/Min and the recirculation flow rate is controlled from 0 to 500 L/Min, or the air flow rate is controlled from 0 to 10 SCM/Min and the recirculation flow rate is controlled from 5 to 400 L/Min. Even more preferably, the air flow rate is controlled from 0 to 1 SCM/Min and the recirculation flow rate is controlled from 5 to 400 L/Min.

In the embodiment of FIG. 1, tubing length, inter dimension of tubing and hose barb, liquid volume and liquid level in the recirculation tank are exemplary parameters to achieve a control of the air flow rate and the recirculation flow rate within specific ranges for the powder induction system 100. For example, preferred range of tubing length of at pump inlet is from 0.1 to 15 meter, inter dimension of tubing and hose barb at pump inlet are from 0.5 to 5.5 centimeter, liquid volume in the recirculation tank is from 1 to 5000 litter, and liquid level in recirculation tank is from 0.001 to 10 meter.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub-combination or a variation of a subcombination. Similarly, while operations are depicted in the drawings in a particular order, this should not be understood as requiring that such operations be performed in the particular order shown or in sequential order, or that all illustrated operations be performed, to achieve desirable results. Only a few examples and implementations are disclosed. Variations, modifications and enhancements to the described examples and implementations and other implementations may be made based on what is disclosed.

1. A method of inducing powder for pharmaceutical production, the method comprising:
inducing the powder in a powder container into a powder flow pathway toward a branched lumen, wherein the powder container is a single use closed container, and wherein an air inlet is coupled to the powder flow pathway downstream of the powder container and upstream of the branched lumen;
inducing the powder from the branched lumen into a recirculation flow pathway toward a mix tank, wherein a pump assembly is located in the recirculation flow pathway; and
recirculating the powder in the recirculation flow pathway toward the mix tank, wherein the powder flow pathway and the recirculation flow pathway are collectively an enclosed pathway in which an air flow rate from the air inlet is controlled from 0 to 10 SCM/Min and recirculation flow rate in the recirculation flow pathway is controlled from 0 to 500 L/Min.

2. The method of claim 1, wherein the powder container is a bag.

3. The method of claim 1, wherein the powder container has a vent through which the air from the air inlet exits.

4. The method of claim 1, wherein the air flow rate from the air inlet is controlled from 0 to 1 SCM/Min and recirculation flow rate in the recirculation flow pathway is controlled from 5 to 400 L/Min.

5. The method of claim 1, wherein the branched lumen is a manifold.

6. The method of claim 5, wherein the pump assembly is located downstream of the manifold relative to an entryway into the recirculation flow pathway and the pump assembly is located upstream of the mix tank relative to the entryway into the recirculation flow pathway.

7. The method of claim 5, wherein the powder is initially induced into the recirculation flow pathway via the manifold, then into the pump assembly, and then into the mix tank along the recirculation flow pathway.

8. The method of claim 1, wherein the powder container is located at a height relative to a ground level wherein the height is lower than a liquid height of the container relative to ground level.

9. The method of claim 1, wherein the wherein the branched lumen is an eductor.

10. The method of claim 9, wherein the pump assembly is located downstream of the mix tank relative to an entryway into the recirculation flow pathway and upstream of the eductor relative to the entryway into the recirculation flow pathway.

11. The method of claim 9, wherein the powder is initially induced into the recirculation flow pathway via the eductor, then into the mix tank, and then into the pump assembly along the recirculation flow pathway.

12. The method of claim 9, wherein the eductor has an internal lumen lumen sized and shaped to achieve the Venturi effect as fluid flows through the internal lumen.

13. A powder induction system, comprising:
a powder container containing a powder, the powder container positioned along a powder flow pathway such that the powder container introduces the powder into the powder flow pathway;
an air inlet coupled to the powder flow pathway, the air inlet configured to introduce air into the powder flow pathway downstream of the powder container;
a manifold coupled to the powder flow pathway downstream of the air inlet, wherein the manifold fluidly connects the powder flow pathway to a recirculation flow pathway; and
a pump assembly coupled to the recirculation flow pathway, wherein the pump assembly is configured to cause a pressure differential to cause powder to pass from the powder container through the powder flow pathway and into the recirculation flow pathway toward a mix tank, wherein the manifold introduces powder into the recirculation flow pathway upstream of the pump assembly.

14. The powder induction system of claim 13, wherein the powder container is an enclosed container having an outlet.

15. The powder induction system of claim 14, wherein the outlet of the powder container communicates with the air inlet via a tube.

16. The powder induction system of claim 14, further comprising a valve interposed between the outlet of the powder container and the air inlet.

17. The powder induction system of claim 14, further comprising a clamp interposed between the outlet of the powder container and the air inlet.

18. The powder induction system of claim 13, wherein the pump assembly includes a pump head and pump that removably couples to a pump mechanism.

19. The powder induction system of claim 13, further comprising the mix tank.

20. The powder induction system of claim 13, wherein the powder container is a bag.

21. The powder induction system of claim 13, wherein the powder container includes a vent and an air filter.

22. A powder induction system, comprising:
a powder container containing a powder, the powder container positioned along a powder flow pathway such that the powder container introduces the powder into the powder flow pathway;
an air inlet coupled to the powder flow pathway, the air inlet configured to introduce air into the powder flow pathway downstream of the powder container;
an eductor coupled to the flow pathway downstream of the air inlet, wherein the eductor fluidly connects the powder flow pathway to a recirculation flow pathway and introduces the powder into the powder flow pathway; and
a pump assembly coupled to the recirculation flow pathway, wherein the pump assembly is configured to cause a pressure differential to cause powder to pass from the powder container through the powder flow pathway and into the recirculation flow pathway toward a mix tank via the inductor, wherein the powder is added into a liquid stream of the recirculation flow pathway by a vacuum generated by the eductor, wherein the eductor introduces powder into the recirculation flow pathway downstream of the pump assembly.

23. The powder induction system of claim 22, wherein the powder container is an enclosed container having an outlet.

24. The powder induction system of claim 22, wherein the outlet of the powder container communicates with the air inlet via a tube.

25. The powder induction system of claim 22, further comprising a valve interposed between the outlet of the powder container and the air inlet.

26. The powder induction system of claim 22, further comprising a clamp interposed between the outlet of the powder container and the air inlet.

27. The powder induction system of claim 22, wherein the pump assembly includes a pump head and pump that removably couples to a pump mechanism.

28. The powder induction system of claim 22, further comprising the mix tank.

29. The powder induction system of claim 22, wherein the powder container is a bag.

30. The powder induction system of claim 22, wherein the powder container includes a vent and an air filter.
